(19) United States
(12) Patent Application Publication
(10) Pub. No.: US 2023/0063022 A1
(43) Pub. Date: Mar. 2, 2023

(54) METHOD FOR PRODUCING CATHODE ACTIVE MATERIAL, CATHODE ACTIVE MATERIAL, AND LITHIUM ION SECONDARY BATTERY

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 17/893,617

(22) Filed: Aug. 23, 2022

(30) Foreign Application Priority Data
Sep. 2, 2021 (JP) 2021-142971

(51) Int. Cl. H01M 4/525; H01M 4/04; H01M 4/485; H01M 4/505; H01M 10/0525

(52) U.S. Cl. CPC H01M 4/525; H01M 4/0471; H01M 4/485; H01M 4/505; H01M 10/0525; H01M 2004/021

(57) ABSTRACT

A main object of the present disclosure is to provide a method for producing a cathode active material capable of obtaining a cathode active material with small particle size. The present disclosure achieves the object by providing a method for producing a cathode active material including a composite oxide, the method comprising: a preparing step of preparing a precursor containing Li, and Me, which is at least one kind of Ni, Co, Mn, Al and Fe; and a burning step of burning the precursor to obtain the composite oxide; wherein in the preparing step, a polymercontaining aqueous solution in which a water-soluble polymer is dissolved is used to introduce the water-soluble polymer into a secondary particle configured in the precursor.

### TECHNICAL FIELD

The present disclosure relates to a method for producing a cathode active material, a cathode active material, and a lithium ion secondary battery.

### BACKGROUND

In recent year, along with a rapid spread of electronic equipment such as a mobile phone, the development of a battery used as a power source therefor has been advanced. Also, in the automobile industry, a battery used for a hybrid electric vehicle (HEV), plug-in hybrid electric vehicle (PHEV) or a battery electric vehicle (BEV) has been advanced. Among various batteries, a lithium ion secondary battery has an advantage of having high energy density.

The lithium ion secondary battery usually includes a cathode layer, an anode layer, and an electrolyte layer arranged between the cathode layer and the anode layer. As a cathode active material used in a cathode layer, a composite oxide containing Li has been known. For example, Patent Literature 1 discloses a method for producing a cathode active material for lithium ion secondary battery including a lithium nickel composite oxide. Also, Patent Literature 1 discloses that an organic compound particle is used to improve crushability of a sintered body.

Patent Literature 2 discloses a cathode active material for non-aqueous secondary battery comprising a composite oxide particle represented by a general formula LiNiₐCo_{b}Mn_{c}O₂ (a+b+c=1, 0<a<1, 0<b<1, 0<c<1). Also, Patent Literature 3 discloses a precursor of a cathode active material for lithium ion secondary battery. Further, Patent Literature 4 discloses a cathode active material for lithium ion secondary battery configured by a secondary particle formed by aggregation of primary particles. Furthermore, Patent Literature 5 discloses a cathode active material of a non-aqueous electrolyte secondary battery wherein a nickel composite hydroxide is burned with a lithium compound.

### CITATION LIST

### Patent Literatures

Patent Literature 1: Japanese Patent Application Laid-Open (JP-A) No. 2020-113429

Patent Literature 2: JP-A No. 2016-081800

Patent Literature 3: JP-A No. 2020-177860

Patent Literature 4: JP-A No. 2021-048071

Patent Literature 5: JP-A No. 2021-024764

### SUMMARY OF DISCLOSURE

### Technical Problem

It has been desired to reduce the particle size of a cathode active material from the viewpoint of decreasing battery resistance. The present disclosure has been made in view of the above circumstances, and a main object thereof is to provide a method for producing a cathode active material capable of obtaining a cathode active material with small particle size.

### Solution to Problem

The present disclosure provides a method for producing a cathode active material including a composite oxide, the method comprising: a preparing step of preparing a precursor containing Li, and Me, which is at least one kind of Ni, Co, Mn, Al and Fe; and a burning step of burning the precursor to obtain the composite oxide; wherein in the preparing step, a polymer-containing aqueous solution in which a water-soluble polymer is dissolved is used to introduce the water-soluble polymer into a secondary particle configured in the precursor.

According to the present disclosure, by using a precursor with a water-soluble polymer introduced into its secondary particle, a cathode active material with small particle size may be obtained.

In the disclosure, the precursor may be a mixture including a Me compound containing the Me, and a Li compound containing the Li; and at least one of the Me compound and the Li compound may be the secondary particle.

In the disclosure, the preparing step may include: a raw material solution producing treatment of producing a raw material solution by dissolving a Me raw material containing the Me in a solvent; a precipitation producing treatment of producing a precipitation that is a Me compound containing the Me, from the raw material solution; a washing treatment of washing the Me compound; and a mixing treatment of mixing the washed the Me compound with the Li compound; wherein in at least one of the raw material solution producing treatment, the precipitation producing treatment, the washing treatment and the mixing treatment, the polymer-containing aqueous solution may be used to introduce the water-soluble polymer into the secondary particle.

In the disclosure, the water-soluble polymer may be introduced into the secondary particle by washing the Me compound using the polymer-containing aqueous solution, in the washing treatment.

In the disclosure, the water-soluble polymer may include at least one kind of a cellulose derivative, a (meth)acrylic polymer, and a polyvinyl alcohol-based polymer.

In the disclosure, the water-soluble polymer may include a carboxymethyl cellulose; and a concentration of the carboxymethyl cellulose in the polymer-containing aqueous solution may be 0.5 weight% or more and 2.0 weight% or less.

In the disclosure, the method for producing the cathode active material in the disclosure may further comprise a cracking step of cracking the composite oxide, after the burning step.

The present disclosure also provides a cathode active material comprising a composite oxide, wherein the composite oxide contains Li, and Me, which is at least one kind of Ni, Co, Mn, Al and Fe; and in the composite oxide, from a granule side in an accumulated particle distribution as a volume reference, when D₁₀ designates a particle size of 10% accumulation, D₅₀ designates a particle size of 50% accumulation, and D₉₀ designates a particle size of 90% accumulation, D₅₀ is 0.3 µm or more and 1.2 µm or less, and (D₉₀ - D₁₀)/D₅₀ is 0.9 or more and 1.7 or less; and a residual Na concentration in the composite oxide is 0.010 weight% or more and 0.134 weight% or less.

According to the present disclosure, with the specified particle size of the cathode active material, a battery with low resistance may be obtained.

The present disclosure also provides a lithium ion secondary battery comprising a cathode layer, an anode layer, and an electrolyte layer arranged between the cathode layer and the anode layer; wherein the cathode layer contains the above-described cathode active material.

According to the present disclosure, the specified cathode active material is used, and thus the lithium ion secondary battery may have low resistance.

### Advantageous Effects of Disclosure

The method for producing the cathode active material in the present disclosure exhibits an effect of obtaining a cathode active material with small particle size.

### BRIEF DESCRIPTION OF DRAWINGS

FIG. 1 is a flow chart exemplifying the method for producing the cathode active material in the present disclosure.

FIG. 2 is a schematic side view exemplifying the burning step in the present disclosure.

FIG. 3 is a flow chart exemplifying the preparing step in the present disclosure.

FIG. 4 is a schematic cross-sectional view exemplifying the lithium ion secondary battery in the present disclosure.

### DESCRIPTION OF EMBODIMENTS

The method for producing the cathode active material, the cathode active material, and the lithium ion secondary battery in the present disclosure will be hereinafter described in details.

### A. Method for Producing Cathode Active Material

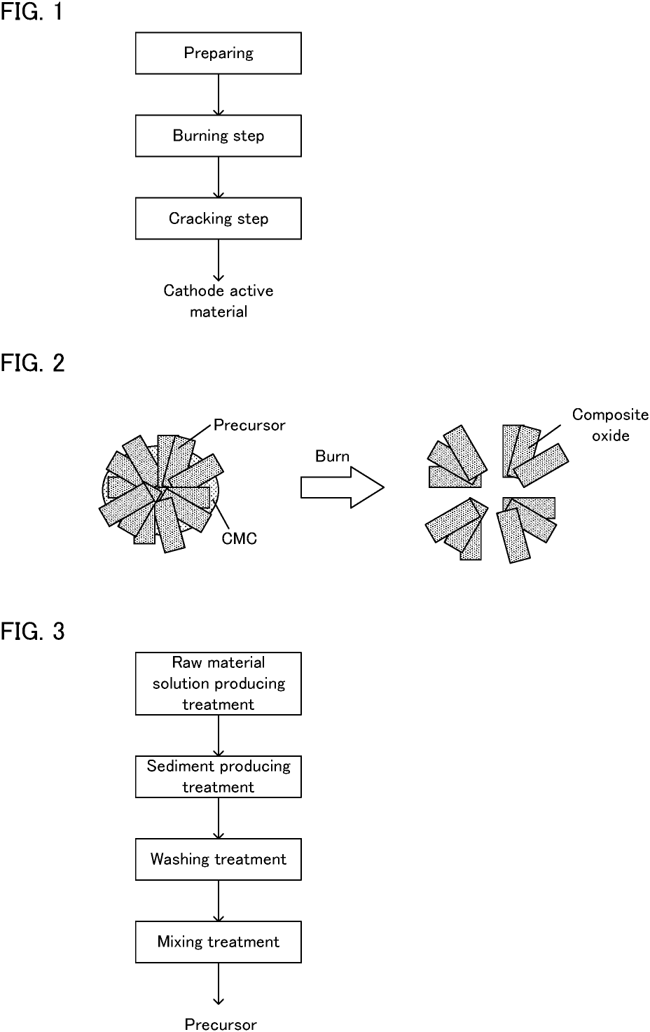

FIG. 1 is a flow chart exemplifying the method for producing the cathode active material in the present disclosure. In FIG. 1, first, a precursor containing Li, and Me, which is at least one kind of Ni, Co, Mn, Al and Fe, is prepared (preparing step). In the preparing step, a polymer-containing aqueous solution in which a water-soluble polymer is dissolved is used to introduce the water-soluble polymer into a secondary particle configured in the precursor. Next, the precursor is burned to obtain the composite oxide (burning step). Next, the burned composite oxide is cracked (cracking step). Thereby, a cathode active material is obtained.

According to the present disclosure, by using a precursor with a water-soluble polymer introduced into its secondary particle, a cathode active material with small particle size may be obtained. Also, by using the cathode active material with small particle size, battery resistance is decreased. FIG. 2 is a schematic side view exemplifying the burning step in the present disclosure. As shown in FIG. 2, the precursor before burning includes a secondary particle, and a water-soluble polymer (such as carboxymethylcellulose; CMC) is introduced into the secondary particle. At the time of burning, CMC is decomposed to break the structure of the secondary particle. As a result, the cathode active material (composite oxide) with small particle size is obtained. Incidentally, in FIG. 2, for convenience, the cross-section of the primary particle is illustrated as a square shape, but the shape is not limited to the square shape, but examples of the shape may include other shapes such as a circle shape. The shape of the primary particle may be, for example, a stick shape, and may be a ball shape.

As described above, Patent Literature 1 discloses that an organic compound particle is used to improve crackability of a sintered body. However, the organic compound particle is solid and thus cannot break into the secondary particle. Therefore, the structure of the secondary particle does not break, but maintains. In particular, it is described in paragraph [0089] in Patent Literature 1 that the secondary particle itself is not broken. In contrast, in the present disclosure, by positively introducing the water-soluble polymer into the secondary particle, the structure of the secondary particle is broken at the time of burning. Thereby, the cathode active material with small particle size is obtained.

### 1. Preparing Step

The preparing step in the present disclosure is a step of preparing a precursor containing Li, and Me, which is at least one kind of Ni, Co, Mn, Al and Fe. Also, in the preparing step, a polymer-containing aqueous solution in which a water-soluble polymer is dissolved is used to introduce the water-soluble polymer into a secondary particle configured in the precursor. In other words, inside the secondary particle configured in the precursor, the water-soluble polymer is introduced.

In the present disclosure, “secondary particle configured in the precursor” refers to the secondary particle corresponding to at least one compound out of one or two or more compounds configuring the precursor overall. Also, “secondary particle” refers to a particle formed by aggregation of primary particles. Also, “into (in/inside) the secondary particle” refers to voids present among the aggregated primary particles.

Also, the precursor may be a mixture including a Me compound containing Me, and a Li compound containing Li. In this case, at least one of the Me compound and the Li compound is preferably the secondary particle. The water-soluble polymer may be introduced into the Me compound that is the secondary particle. Also, the water-soluble polymer may be introduced into the Li compound that is the secondary particle.

The Me compound is not particularly limited if it contains Me, and is capable of synthesizing the desired composite oxide by burning. Examples of the Me compound may include a hydroxide containing Me and an oxide containing Me. Also, the precursor may contain just one kind of the Me compound, and may contain two kinds or more of the Me compound. For example, when the precursor contains Ni, Co, and Mn as the Me, examples of the one kind of the Me compound may include a single compound containing Ni, Co and Mn. Meanwhile, examples of the two kinds or more of the Me compound may include a mixture of a Ni compound, a Co compound and a Mn compound.

The Li compound is not particularly limited if it contains Li, and is capable of synthesizing the desired composite oxide by burning. Examples of the Li compound may include a lithium carbonate, a lithium hydroxide, lithium nitrate and lithium acetate.

Also, in the preparing step, a polymer-containing aqueous solution in which a water-soluble polymer is dissolved is used to introduce the water-soluble polymer into a secondary particle configured in the precursor. The polymer-containing aqueous solution includes a water-soluble polymer and water. Examples of the water-soluble polymer may include a cellulose derivative such as carboxymethylcellulose; a (meth)acrylic polymer such as polyacrylate and polymethacrylate; and a polyvinyl alcohol-based polymer such as polyvinyl alcohol and a polyvinyl alcohol derivative. The decomposition temperature of the water-soluble polymer is, for example, 600° C. or less and may be 500° C. or less. Meanwhile, the decomposition temperature of the water-soluble polymer is, for example, 120° C. or more and may be 200° C. or more. Incidentally, the decomposition temperature of the water-soluble polymer refers to a temperature at which the water-soluble polymer is thermally decomposed. Also, the weight average molecular weight of the water-soluble polymer is, for example, 1000 or more and may be 10,000 or more.

The concentration of the water-soluble polymer in the polymer-containing aqueous solution is not particularly limited, but for example, it is 0.1 weight% or more and 5 weight% or less. Also, when the polymer-containing aqueous solution includes carboxymethylcellulose as the water-soluble polymer, the concentration of the carboxymethylcellulose in the polymer-containing aqueous solution is, for example, 0.5 weight% or more. Meanwhile, the concentration is, for example, 2.0 weight% or less, and may be 1.5 weight% or less. The viscosity of the polymer-containing aqueous solution is, for example, 100 Pa·s or less, and preferably 80 Pa·s or less.

The method for introducing the water-soluble polymer into the secondary particle configured in the precursor using the polymer-containing aqueous solution is not particularly limited. Examples of the method may include a method in which the polymer-containing aqueous solution is brought into contact the secondary particle configured in the precursor to permeate the inside of the secondary particle configured in the precursor with the polymer-containing aqueous solution, and then the product is dried to remove water included in the polymer-containing aqueous solution. Also, the timing of introducing the water-soluble polymer is not particularly limited. For example, the Me compound and the Li compound are mixed, then the polymer-containing aqueous solution is added thereto, and after that, the mixture is dried; thereby, the water-soluble polymer may be introduced to the mixture. Also, before mixing the Me compound and the Li compound, the water-soluble polymer may be introduced to at least one of the Me compound and the Li compound. Also, the water-soluble polymer may be introduced during the production of the Me compound.

FIG. 3 is a flow chart exemplifying the preparing step in the present disclosure. In FIG. 3, first, a raw material solution is produced by dissolving a Me raw material containing the Me in a solvent (raw material solution producing treatment). For example, the raw material solution is obtained by dissolving an inorganic salt containing Ni, an inorganic salt containing Co and an inorganic salt containing Mn, in water. Next, a precipitation that is a Me compound is produced from the raw material solution (precipitation producing treatment). For example, the precipitation of the Me compound is obtained by neutralizing the raw material solution. Next, the Me compound is filtrated and washed (washing treatment). Next, the washed the Me compound is mixed with the Li compound (mixing treatment). Thereby, the precursor is obtained.

In the raw material solution producing treatment, a raw material solution is produced by dissolving a Me raw material containing the Me in a solvent. Examples of the Me raw material may include a salt containing Me. Examples of such a salt may include a sulfate, a nitrate and a chlorate. Examples of the solvent may include water. In the present disclosure, the water-soluble polymer may be introduced in the raw material solution producing treatment. For example, on the occasion of dissolving the Me raw material in the solvent, the water-soluble polymer may be added at the same time, and the polymer-containing aqueous solution in which the water-soluble polymer is dissolved may be added.

In the precipitation producing treatment, a precipitation that is a Me compound containing the Me is produced from the raw material solution. The method for obtaining the precipitation of the Me compound is not particularly limited, and a general crystallization method can be used. Examples of the crystallization method may include neutralization and concentration. For example, when the raw material solution is acidic, by adding an alkaline solution thereto, the Me compound is obtained. Examples of the alkaline solution may include a sodium hydroxide aqueous solution, a calcium hydroxide aqueous solution, and potassium hydroxide solution. The Me compound is preferably a hydroxide. Meanwhile, when the raw material solution is alkaline, by adding an acidic solution thereto, the Me compound is obtained. Also, a complexation material may be added to the raw material solution. Examples of the complexation material may include an ammonium aqueous solution. In the present disclosure, the water-soluble polymer may be introduced in the precipitation producing treatment. For example, the water-soluble polymer may be added before or after neutralizing the raw material solution, and the polymer-containing aqueous solution with the water-soluble polymer dissolved therein may be added at the same time of neutralizing the raw material solution.

In the washing treatment, the Me compound is washed by a washing solution. Examples of the washing solution may include water. In the present disclosure, the water-soluble polymer may be introduced in the washing treatment. For example, the polymer-containing aqueous solution with the water-soluble polymer dissolved therein may be used as the washing solution.

In the mixing treatment, the washed Me compound is mixed with the Li compound. The details of the Li compound are as described above. In the present disclosure, the water-soluble polymer may be introduced in the mixing treatment. For example, the polymer-containing aqueous solution with the water-soluble polymer dissolved therein may be added at the time of mixing the Me compound with the Li compound.

The shape of the precursor is not particularly limited, and it maybe powder, and may be a molded body.

### 2. Burning Step

The burning step in the present disclosure is a step of burning the precursor to obtain the composite oxide. The burning temperature in the burning step is not particularly limited as long as the desired composite oxide can be obtained. Also, the burning temperature is preferably equal to or more than the decomposition temperature of the water-soluble polymer. The burning temperature is, for example, 500° C. or more, may be 700° C. or more, and may be 900° C. or more. Meanwhile, the burning temperature is, for example, 1500° C. or less. The burning time is, for example, 1 hour or more and may be 5 hours or more. Meanwhile, the burning time is, for example, 30 hours or less.

Examples of the atmospheres during burning may include an oxygen-containing atmosphere. Examples of the oxygen-containing atmosphere may include an atmospheric pressure atmosphere, and an atmosphere in which an oxygen gas is added to an inert gas. Examples of the burning method may include a method using a furnace such as a muffle furnace.

### 3. Cracking Step

The cracking step in the present disclosure is a step of cracking the composite oxide after the burning step. By performing the cracking step, sintered neckings among second particles are cracked. In the cracking step, usually, the structure of the second particle itself is not broken. Examples of the method for cracking the composite oxide may include a method of applying mechanical energy, and a specific example thereof is jet-milling. Also, conditions for cracking are appropriately adjusted so as to obtain the later described cathode active material.

### 4. Cathode Active Material

The cathode active material in the present disclosure includes a composite oxide containing Li, and Me, which is at least one kind of Ni, Co, Mn, Al and Fe.

The composite oxide may contain at least Ni as the Me. Similarly, the composite oxide may contain at least Co as the Me. Similarly, the composite oxide may contain at least Mn as the Me. Also, the composite oxide may contain at least one kind of Ni, Co, and Mn, as the Me. Similarly, the composite oxide may contain at least one kind of Ni, Co, and Al, as the Me. Also, the composite oxide may contain Me^{X} that is at least one kind of Ni, Co, and Mn, as the Me, and a part of the Me^{X} may be substituted with Me^{Y} that is at least one of Al and Fe.

In the composite oxide, from a granule side in an accumulated particle distribution as a volume reference, D₁₀ designates a particle size of 10% accumulation, D₅₀ designates a particle size of 50% accumulation, and D₉₀ designates a particle size of 90% accumulation. The D₅₀ is, for example, 0.3 µm or more, may be 0.4 µm or more, and may be 0.5 µm or more. If the D₅₀ is too small, aggregation of particles easily occurs. Meanwhile, the D₅₀ is, for example, 1.2 µm or less and may be 1.1 µm or less.

Also, (D₉₀ - D₁₀)/D₅₀ is an index that shows the spread of the particle distribution. The value of (D₉₀ - D₁₀)/D₅₀ is, for example, 0.9 or more and may be 1.0 or more. Meanwhile, (D₉₀ - D₁₀) / D₅₀ is, for example, 1.7 or less and may be 1.5 or less. When (D₉₀ - D₁₀)/D₅₀ is in the specified range, a filling rate of the cathode active material in the cathode layer improves.

The composite oxide preferably has high bulk density. The reason therefor is to improve the energy density per volume. The bulk density of the composite oxide is, for example, 1.8 g/cm³ or more and may be 2.1 g/cm³ or more. The bulk density of the composite oxide is, for example, 3.0 g/cm³ or less and may be 2.5 g/cm³ or less.

The composite oxide may contain a residual Na. For example, when a sodium salt of polymer is used as the water-soluble polymer, residual Na is generated in the composite oxide after burning. The residual Na concentration in the composite oxide is, for example, 0.010 weight% or more, may be 0.020 weight% or more and may be 0.030 weight% or more. Meanwhile, the residual Na concentration in the composite oxide is, for example, 0.134 weight% or less, and may be 0.100 weight% or less.

The composite oxide in the present disclosure preferably includes a crystal phase. Examples of the crystal phase may include a rock salt bed type crystal phase and a spinel type crystal phase. The present disclosure may also provide a cathode active material obtained by the method for producing the cathode active material described above.

### B. Cathode Active Material

The cathode active material in the present disclosure is a cathode active material comprising a composite oxide, wherein the composite oxide contains Li, and Me, which is at least one kind of Ni, Co, Mn, Al and Fe; and in the composite oxide, from a granule side in an accumulated particle distribution as a volume reference, when D₁₀ designates a particle size of 10% accumulation , D₅₀ designates a particle size of 50% accumulation , and D₉₀ designates a particle size of 90% accumulation , D₅₀ is 0.3 µm or more and 1.2 µm or less, and (D₉₀ - D₁₀)/D₅₀ is 0.9 or more and 1.7 or less; and a residual Na concentration in the composite oxide is 0.01 weight% or more and 0.1 weight% or less.

According to the present disclosure, with the specified particle size of the cathode active material, a battery with low resistance may be obtained. The details of the cathode active material in the present disclosure are in the same contents as those described in "A. Method for producing cathode active material" above. Also, the cathode active material in the present disclosure is used in a battery.

### C. Lithium Ion Secondary Battery

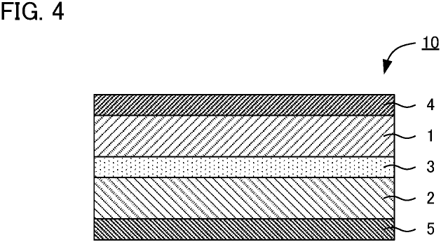

FIG. 4 is a schematic cross-sectional view exemplifying the lithium ion secondary battery in the present disclosure. Lithium ion secondary battery 10 illustrated in FIG. 4 includes cathode layer 1, anode layer 2, electrolyte layer 3 arranged between the cathode layer 1 and the anode layer 2, cathode current collector 4 for collecting currents of the cathode layer 1, and anode current collector 5 for collecting currents of the anode layer 2. The cathode layer 1 contains the cathode active material described in "B. Cathode active material" above.

According to the present disclosure, the specified cathode active material is used, and thus the lithium ion secondary battery may have low resistance.

The cathode layer contains at least a cathode active material. The cathode active material is in the same contents as those described in "B. Cathode active material" above. The cathode layer may contain at least one of an electrolyte, a conductive material, and a binder, as required. Details of the electrolyte will be described later. Examples of the conductive material may include a carbon material. Examples of the carbon material may include a particulate carbon material such as acetylene black (AB) and Ketjen black (KB), and a fiber carbon material such as carbon fiber, carbon nanotube (CNT), and carbon nanofiber (CNF). Examples of the binder may include a fluorine-containing binder such as polyvinylidene fluoride (PVDF) and polytetra fluoroethylene (PTFE). Also, the thickness of the cathode layer is, for example, 0.1 µm or more and 1000 µm or less.

The anode layer contains at least an anode active material. Examples of the anode active material may include a Li-based active material such as a metal lithium and a lithium alloy; a carbon-based active material such as graphite and hard carbon; an oxide-based active material such as lithium titanate; and a Si-based active material such as a simple substance of Si, a Si alloy, and a silicon oxide. The anode layer may contain at least one of an electrolyte, a conductive material, and a binder, as required. These materials are in the same contents as those described above. Also, the thickness of the anode layer is, for example, 0.1 µm or more and 1000 µm or less.

The electrolyte layer contains at least an electrolyte. Examples of the electrolyte may include a solution electrolyte (liquid electrolyte), a gel electrolyte and a solid electrolyte. The liquid electrolyte contains, for example, a lithium salt and a solvent. Examples of the lithium salt may include an inorganic lithium salt such as LiPF₆, LiBF₄, LiClO₄ and LiAsF₆; and an organic lithium salt such as LiCF₃SO₃, LiN(SO₂CF₃)₂, LiN(SO₂C₂F₅)₂, and LiC(SO₂CF₃)₃. Examples of the solvent may include ethylene carbonate (EC), propylene carbonate (PC), butylene carbonate (BC), dimethyl carbonate (DMC), diethyl carbonate (DEC) and ethyl methyl carbonate (EMC).

The gel electrolyte is usually obtained by adding a polymer to a liquid electrolyte. Examples of the polymer may include a polyethylene oxide and a polypropylene oxide. Examples of the solid electrolyte may include an organic solid electrolyte such as a polymer electrolyte; and an inorganic solid electrolyte such as a sulfide solid electrolyte and an oxide solid electrolyte. Also, the thickness of the electrolyte layer is, for example, 0.1 µm or more and 1000 µm or less. The electrolyte layer may include a separator.

Examples of the application of the lithium ion secondary battery in the present disclosure may include a power source for vehicles such as hybrid electric vehicles (HEV), plug-in hybrid electric vehicles (PHEV), battery electric vehicles (BEV), fuel cell electric vehicles and diesel powered automobiles. Also, the lithium ion secondary battery in the present disclosure may be used as a power source for moving bodies other than vehicles (such as rail road transportation, vessel and airplane), and may be used as a power source for electronic products such as information processing equipment.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

As Me raw materials, NiSO₄, CoSO₄ and MnSO₄ were prepared, and these were dissolved in an ion-exchanged water to produce a raw material solution (concentration: 30 weight%). The molar ratio of Ni, Co and Mn in the raw material solution was Ni : Co : Mn = 1 : 1 : 1.

Next, a certain amount of NH₃ aqueous solution (complexation material) was put in a reaction vessel, and nitrogen substitution was performed by stirring with a stirrer. Into the reaction vessel, NaOH was added to adjust pH to alkaline. The raw material solution and the NH₃ aqueous solution were dropped while controlling pH inside the reaction vessel to a constant level with NaOH, and thereby a Me compound (secondary particle of hydroxide) was deposited.

Next, the solution including the Me compound was filtrated, and the residue (Me compound) left on the filter paper was washed by a polymer-containing aqueous solution in which a carboxymethylcellulose-sodium salt (CMC-Na) was dissolved in the concentration of 0.5 weight%. After that, the product was dried at 120° C. for 16 hours to evaporate water. Thereby, CMC was introduced into the Me compound.

Next, the CMC-introduced Me compound and a Li compound (Li₂CO₃) were mixed by a mortar. The obtained mixture was burned at 1000° C. for 10 hours using a muffle furnace to obtain a composite oxide. The obtained composite oxide was cracked by jet milling to obtain a cathode active material.

### Example 2

A cathode active material was obtained in the same manner as in Example 1 except that the CMC concentration in the polymer-containing aqueous solution was changed to 1.0 weight%.

### Example 3

A cathode active material was obtained in the same manner as in Example 1 except that the CMC concentration in the polymer-containing aqueous solution was changed to 1.5 weight%.

### Example 4

A cathode active material was obtained in the same manner as in Example 1 except that the CMC concentration in the polymer-containing aqueous solution was changed to 2.0 weight%.

### Comparative Example 1

A cathode active material was obtained in the same manner as in Example 1 except that the CMC concentration in the polymer-containing aqueous solution was changed to 0 weight%.

### Evaluation

### Particle Distribution Measurement

A particle distribution measurement was respectively conducted to the cathode active materials obtained in Examples 1 to 4 and Comparative Example 1. In the measurement, a laser diffraction scattering particle size distribution measurement device (MT3000 from MicrotracBEL Corp.) was used, and from a granule side in an accumulated particle distribution as a volume reference, the particle size of 10% accumulation D₁₀, the particle size of 50% accumulation D₅₀, and the particle size of 90% accumulation D₉₀ were obtained. The results are shown in Table 1.

### Bulk Density Measurement

A bulk density measurement was respectively conducted to the cathode active materials obtained in Examples 1 to 4 and Comparative Example 1. In the measurement, a powder characteristics tester (Powder Tester PT-X from HOSOKAWA MICRON CORPORATION) was used with the conditions of, stroke of tap: 3 mm, revolution number: 200 times, and speed: 100 times/minute. The results are shown in Table 1.

### Residual Na Amount Measurement

A residual Na amount measurement was respectively conducted to the cathode active materials obtained in Examples 1 to 4 and Comparative Example 1. In the measurement, an ICP emission spectrometer (ICPE-9800 from Shimadzu Corporation) was used. The results are shown in Table 1.

### Initial Resistance Measurement

A battery was respectively produced using the cathode active materials obtained in Examples 1 to 4 and Comparative Example 1, and the initial resistance of the battery was respectively measured. The method for producing the battery was as follows. First, the obtained cathode active material, a conductive material (acetylene black) and a binder (polyvinylidene fluoride) were weighed in the weight ratio of the cathode active material : the conductive material : the binder = 88 : 10 : 2, and these were mixed. A dispersion medium was added to the obtained mixture and agitated to obtain a cathode slurry. The obtained cathode slurry was pasted on a cathode current collector using a film applicator (with film thickness adjustment function, from Allgood Corporation), and then dried at 80° C. for 5 minutes. Thereby, a cathode structure body including a cathode current collector and a cathode layer was obtained.

Next, an anode active material (natural graphite) and a binder (SBR and CMC) were mixed, and a dispersion medium was added to the obtained mixture and agitated to obtain an anode slurry. The obtained anode slurry was pasted on an anode current collector using a film applicator, and then dried at 80° C. for 5 minutes. Thereby, an anode structure body including an anode current collector and an anode layer was obtained.

The cathode layer in the cathode structure body and the anode layer in the anode structure body were faced to each other interposing a separator, winded, and a liquid electrolyte was injected thereto to obtain a battery. A liquid electrolyte was produced by dissolving 1 M of LiPF₆ in a mixture solvent containing EC, DMC and EMC in the volume ratio of EC : DMC : EMC = 3 : 4 : 3, and used.

The obtained battery was charged until 4.1 V, and then discharged until 3.0 V. After that, the battery was charged until 3.7 V, and placed still at 60° C. for 9 hours. After that, charge resistance of the battery for 10 seconds at -10° C., 3.7 V and 1C was measured as the initial resistance. The results are shown in Table 1. Incidentally, the initial resistance was obtained as a relative value when Comparative Example 1 was 100%.

### Dispersibility of Active Material

A cathode layer was respectively produced using the cathode active materials obtained in Examples 1 to 4 and Comparative Example 1, in the same manner as above. The cross-section of the obtained cathode layer was observed with a scanning electron microscope (SEM), and the dispersibility of the cathode active material in the cathode layer was evaluated. The dispersibility of the cathode active material was calculated by the following formula, using an image of the cross-section of the cathode layer (magnification of 1000 times, 20 µm by 100 µm) divided into 20 (1 µm by 1 µm).

$${σ}^{2} = \frac{1}{\text{n}} {\sum }_{\text{i=1}}^{\text{n}} {\left({\text{X}}_{\text{i}} - {\text{X}}_{\text{ave}}\right)}^{2}$$

In the formula, σ² is the dispersibility of the cathode active material, n is the dividing number (n = 20), Xᵢ is the volume of the cathode active material in the i^{th} image, and Xₐᵥₑ is an average of each volume of the cathode active material.

Table 1

| | CMC concentration (%) | D₅₀ (µm) | (D₉₀- D₁₀)/D₅₀ | Bulk density (g/cm³) | Residual Na amount (wt%) | Dispersibility of active material | Initial resistance (%) |
|---|---|---|---|---|---|---|---|
| Comp. Ex. 1 | 0 | 5.3 | 0.7 | 1.5 | 0.005 | 10.5 | 100 |
| Example 1 | 0.5 | 1.0 | 1.5 | 2.1 | 0.010 | 79.8 | 87 |
| Example 2 | 1.0 | 0.3 | 1.7 | 2.3 | 0.043 | 32.3 | 82 |
| Example 3 | 1.5 | 0.6 | 1.4 | 2.1 | 0.100 | 3.2 | 86 |
| Example 4 | 2.0 | 1.2 | 0.9 | 1.8 | 0.134 | 35.2 | 92 |

As shown in Table 1, the D₅₀ of the cathode active materials in Examples 1 to 4 were smaller than that in Comparative Example 1. In particular, the D₅₀ was remarkably small in Examples 2 and 3. Also, (D₉₀ - D₁₀)/D₅₀ in Examples 1 to 4 was respectively higher than that of Comparative Example 1, and contribution to the improvement in filling rate of the cathode active material in the cathode layer was suggested. In particular, (D₉₀ - D₁₀)/D₅₀ in Examples 1 to 3 were remarkably high. Also, the bulk density of Examples 1 to 4 was respectively higher than that of Comparative Example 1, and contribution to the improvement in energy density per volume was confirmed. In particular, the bulk density in Examples 1 to 3 were remarkably high. Also, Na residue derived from CMC-Na was confirmed in Examples 1 to 4. Also, the dispersibility of the cathode active material was remarkably high in Example 3. Also, the initial resistance of Examples 1 to 4 was respectively lower than that of Comparative Example 1, and the improvement in battery performance was confirmed. In particular, the initial resistances of Examples 1 to 3 were remarkably low.

### REFERENCE SINGS LIST

1 cathode layer

2 anode layer

3 electrolyte layer

4 cathode current collector

5 anode current collector

10 lithium ion secondary battery

What is claimed is:

1. A method for producing a cathode active material including a composite oxide, the method comprising:
a preparing step of preparing a precursor containing Li, and Me, which is at least one kind of Ni, Co, Mn, Al and Fe; and
a burning step of burning the precursor to obtain the composite oxide; wherein
in the preparing step, a polymer-containing aqueous solution in which a water-soluble polymer is dissolved is used to introduce the water-soluble polymer into a secondary particle configured in the precursor.

2. The method for producing the cathode active material according to claim 1, wherein
the precursor is a mixture including a Me compound containing the Me, and a Li compound containing the Li; and
at least one of the Me compound and the Li compound is the secondary particle.

3. The method for producing the cathode active material according to claim 1, wherein
the preparing step comprising:
a raw material solution producing treatment of producing a raw material solution by dissolving a Me raw material containing the Me in a solvent;
a precipitation producing treatment of producing a precipitation that is a Me compound containing the Me, from the raw material solution;
a washing treatment of washing the Me compound; and
a mixing treatment of mixing the washed the Me compound with the Li compound; wherein
in at least one of the raw material solution producing treatment, the precipitation producing treatment, the washing treatment and the mixing treatment, the polymer-containing aqueous solution is used to introduce the water-soluble polymer into the secondary particle.

4. The method for producing the cathode active material according to claim 3, wherein the water-soluble polymer is introduced into the secondary particle by washing the Me compound using the polymer-containing aqueous solution, in the washing treatment.

5. The method for producing the cathode active material according to claim 1, wherein the water-soluble polymer includes at least one kind of a cellulose derivative, a (meth)acrylic polymer, and a polyvinyl alcohol-based polymer.

6. The method for producing the cathode active material according to of claim 1, wherein
the water-soluble polymer includes a carboxymethyl cellulose; and
a concentration of the carboxymethyl cellulose in the polymer-containing aqueous solution is 0.5 weight% or more and 2.0 weight% or less.

7. The method for producing the cathode active material according to claim 1, further comprising a cracking step of cracking the composite oxide, after the burning step.

8. A cathode active material comprising a composite oxide, wherein
the composite oxide contains Li, and Me, which is at least one kind of Ni, Co, Mn, Al and Fe; and
in the composite oxide, from a granule side in an accumulated particle distribution as a volume reference, when D₁₀ designates a particle size of 10% accumulation , D₅₀ designates a particle size of 50% accumulation, and D₉₀ designates a particle size of 90% accumulation, D₅₀ is 0.3 µm or more and 1.2 µm or less, and (D₉₀ - D₁₀)/D₅₀ is 0.9 or more and 1.7 or less; and
a residual Na concentration in the composite oxide is 0.010 weight% or more and 0.134 weight% or less.

9. A lithium ion secondary battery comprising a cathode layer, an anode layer, and an electrolyte layer arranged between the cathode layer and the anode layer; wherein
the cathode layer contains the cathode active material according to claim 8.
